(19) United States
(12) Patent Application Publication
(10) Pub. No.: US 2008/0257150 A1
(43) Pub. Date: Oct. 23, 2008

(54) PROCESSES FOR THE ADSORPTIVE REMOVAL OF INORGANIC COMPONENTS FROM HYDROGEN CHLORIDE-CONTAINING GASES

(75) Inventors: Aurel Wolf, Wulfrath (DE); Oliver Felix-Karl Schluter, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/103,994

(22) Filed: Apr. 16, 2008

(30) Foreign Application Priority Data
Apr. 17, 2007 (DE) 102007018016.2

(51) Int. Cl. B01D 53/14

(52) U.S. Cl. 95/87; 95/82

(57) ABSTRACT

Processes for removing inorganic impurities from HCl-containing gases, which processes comprise: providing a crude gas stream comprising hydrogen chloride and at least one inorganic component; introducing the crude gas stream into an adsorber bed; adsorbing at least a portion of the at least one inorganic component from the crude gas stream on the adsorber bed to form a purified HCl gas, and removing the purified HCl gas from the adsorber bed.

### BACKGROUND OF THE INVENTION

Various methods exist for the removal of organic impurities from gas streams containing HCl, e.g., of benzene from HCl by washing out with a mixture of H₂SO₄/HOAc/H₂O (DE 24 13 043 A1) or by adsorption on aluminum oxide (GB 1 090 521).

For purification of HCl gas containing phosgene, phosgene is removed by washing out with dichloroethane (DE-A 11 07 18), which is not particularly attractive because of the use of organic halogenated solvents.

Only a few methods are described for the removal of inorganic impurities from hydrogen chloride, which usually proceed via purification of the hydrochloric acid, but not of the gaseous hydrogen chloride.

For purification of hydrochloric acid, e.g., ion exchangers, such as are described in Hydrometallurgy (2005), 77(1-2), 81-88, are employed for the removal of traces of chromium, molybdenum and tungsten. Disadvantages are the low long-term stability of the ion exchangers compared with inorganic oxides (Al, Si) and the relatively poor capacity thereof for regeneration.

The removal of arsenic from gaseous hydrogen chloride by an active charcoal bed is described in U.S. Pat. No. 1,936,078. The temperatures thereby employed are in general very low (<100° C.), and it is not clear whether such a process can be operated at high temperatures. Moreover, the use of such a process for the purification of an O₂-containing HCl gas stream at >250° C. is not possible because of the sensitivity of the active charcoal to oxidation.

In addition, in Deacon product gases the presence of water of reaction leads to the formation of hydrochloric acid at a temperature below 100° C.

The purification processes of the prior art which have been described have the disadvantage that they are not suitable for a purification of HCl gas streams at a temperature above 250° C. in particular, such as occur, for example, in a Deacon process.

### BRIEF SUMMARY OF THE INVENTION

The invention relates, in general, to processes for working up hydrogen chloride-containing gas streams which are contaminated with inorganic compounds, via adsorption to remove contaminants.

More particularly, various embodiments of the present invention relate to the purification of hydrogen chloride-containing process gases from hydrogen chloride oxidations, in particular catalyzed hydrogen chloride oxidations. The various processes in accordance with the present invention provide improved purification of crude gas streams containing hydrogen chloride.

According to the processes of the present invention, this can be effected by removing at least a portion of the inorganic impurities at high temperatures, e.g., greater than 120° C., at normal (standard) pressure, in particular at more than 190° C., by passing the crude gas over an adsorber bed. Hydrochloric acid which can be obtained from hydrogen chloride gases purified according to a process of the present invention contains only traces of inorganic impurities and can be advantageously employed, for example, in electrolysis processes or as a neutralizing agent or as a catalyst in chemical processes.

The various processes in accordance with the present invention also provide a reduction in the loss of valuable material components, such as ruthenium, in the purification of gas streams containing hydrogen chloride which are contaminated with inorganic compounds. This can be achieved by working up the adsorption bed.

One embodiment of the present invention includes a process comprising: providing a crude gas stream comprising hydrogen chloride and at least one inorganic component; introducing the crude gas stream into an adsorber bed; adsorbing at least a portion of the at least one inorganic component from the crude gas stream on the adsorber bed to form a purified HCl gas, and removing the purified HCl gas from the adsorber bed

Another embodiment of the present invention includes a process for the removal of inorganic components from a hot crude gas stream containing hydrogen chloride, the process comprising (A) introduction of the hot HCl-containing contaminated crude gas into an adsorber bed; (B) absorption of metal components from the HCl-containing crude gas on an adsorbent; and (C) removal of purified HCl gas from the adsorber bed.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a gas” herein or in the appended claims can refer to a single gas or more than one gas. Additionally, all numerical values, unless otherwise specifically noted, are understood to be modified by the word “about.”

Inorganic impurities in the context of the present invention are understood to include titanium compounds, in particular titanium chloride, titanium oxides, titanium oxychlorides, ruthenium compounds, in particular ruthenium oxides, ruthenium chlorides, ruthenium oxychlorides, chromium compounds, in particular chromium oxides, chromium chlorides or chromium oxychlorides, tin compounds, in particular tin oxides, tin chlorides, tin oxychlorides, copper compounds, in particular copper oxides, copper chlorides or copper oxychlorides, zirconium compounds, zirconium oxides, zirconium chlorides, zirconium oxychlorides, furthermore compounds of silicon, aluminum gold, silver, bismuth, cobalt, iron, manganese, molybdenum, nickel, magnesium and vanadium, in particular in the form of oxide, chlorides or oxychlorides. Tin compounds, ruthenium compounds or titanium compounds of the above-mentioned type are preferably removed by processes according to the various embodiments of the present invention.

Adsorption agents which can be employed in the adsorber bed for the adsorption carried out during the processes according to the present invention include zeolites, aluminum oxide (preferably as an organometallic complex), SiO₂ (preferably in the form of silica gel), aluminum silicates (preferably in the form of bentonite) and other metal oxides. Gamma-aluminum oxide (γ-aluminum oxide) is a preferred adsorption agent

The BET surface area of the absorption agent, in particular of the aluminum oxide, is preferably 10-1,000 m²/g, more preferably >25 m²/g.

Suitable apparatus types for the preparation of an intensive gas-adsorbent contact for use in the present invention include simple fixed beds, fluidized beds, fluid beds or also fixed beds which are movable as a whole. Another suitable possibility is to employ the adsorber bed in a Deacon reactor, as a heap located after the catalyst bed.

Among the advantages of adsorptive removal of metal components from gas streams is that the purified HCl is suitable for use in HCl electrolysis, in particular by means of an oxygen depletion cathode, as a catalyst and as a neutralizing agent for chemical synthesis without further after-treatment. For example, in HCl electrolysis via an oxygen depletion cathode, tetravalent cations (e.g., tin or titanium compounds) in particular, can raise the cell voltage and in this way lower the life of the electrolysis cells in an undesirable manner. Accordingly, the minimization of such cations is advantageous.

The processes according to the present invention are particularly preferably used if the purified gas stream containing hydrogen chloride originates from a production process for the preparation of chlorine from hydrogen chloride and oxygen, in particular a catalyzed gas phase oxidation of hydrogen chloride with oxygen or a non-thermal reaction of hydrogen chloride and oxygen. Coupling with the catalyzed gas phase oxidation of hydrogen chloride with oxygen (Deacon process) is particularly preferred.

Particularly preferably, as already described above, the catalytic process known as the Deacon process is employed in combination with the process according to the invention. In this process, hydrogen chloride is oxidized with oxygen in an exothermic equilibrium reaction to give chlorine, steam being obtained. The reaction temperature is conventionally 150 to 500° C. and the conventional reaction pressure is 1 to 25 bar. Since this is an equilibrium reaction, it is expedient to operate at the lowest possible temperatures at which the catalyst still has an adequate activity. It is furthermore expedient to employ oxygen in amounts which are in excess of stoichiometric amounts with respect to the hydrogen chloride. For example, a two- to four-fold oxygen excess is conventional. Since no losses in selectivity are to be feared, it may be of economic advantage to operate under a relatively high pressure and accordingly over a longer dwell time compared with normal pressure.

Suitable preferred catalysts for the Deacon process contain ruthenium oxide, ruthenium chloride or other ruthenium compounds on tin oxide, silicon dioxide, aluminum oxide, titanium dioxide or zirconium dioxide as a support. Suitable catalysts can be obtained, for example, by application of ruthenium chloride to the support and subsequent drying or drying and calcining. Suitable catalysts can also contain, in addition to or instead of a ruthenium compound, compounds of other noble metals, for example gold, palladium, platinum, osmium, iridium, silver, copper or rhenium. Suitable catalysts can furthermore contain chromium oxide.

The catalytic hydrogen chloride oxidation can be carried out adiabatically or, preferably, isothermally or approximately isothermally, discontinuously, but preferably continuously as a fluidized or fixed bed process, preferably as a fixed bed process, particularly preferably in tube bundle reactors over heterogeneous catalysts at a reaction temperature of from 180 to 500° C., preferably 200 to 400° C., particularly preferably 220 to 350° C. and under a pressure of from 1 to 25 bar (1,000 to 25,000 hPa), preferably 1.2 to 20 bar, particularly preferably 1.5 to 17 bar and in particular 2.0 to 15 bar.

Conventional reaction apparatuses in which the catalytic hydrogen chloride oxidation is carried out are fixed bed or fluidized bed reactors. The catalytic hydrogen chloride oxidation can preferably also be carried out in several stages.

In the adiabatic, the isothermal or approximately isothermal procedure, several, that is to say 2 to 10, preferably 2 to 6, particularly preferably 2 to 5, in particular 2 to 3 reactors connected in series with intermediate cooling can also be employed. The hydrogen chloride can be added either completely together with the oxygen before the first reactor, or distributed over the various reactors. This connection of individual reactors in series can also be combined in one apparatus.

A further preferred embodiment of a device which is suitable for the process comprises employing a structured catalyst heap in which the catalyst activity increases in the direction of flow. Such a structuring of the catalyst heap can be effected by different impregnation of the catalyst support with the active composition or by different dilution of the catalyst with an inert material. Rings, cylinders or balls of titanium dioxide, zirconium dioxide or mixtures thereof, aluminum oxide, steatite, ceramic, glass, graphite, nickel alloys or high-grade steel can be employed, for example, as the inert material. In the case of the preferred use of shaped catalyst bodies, the inert material should preferably have similar external dimensions.

Suitable shaped catalyst bodies are shaped bodies having any desired shapes, tablets, rings, cylinders, stars, wagon-wheels or balls being preferred and rings, cylinders or star strands being particularly preferred as the shape.

Suitable heterogeneous catalysts are, in particular, ruthenium compounds or copper compounds on support materials, which can also be doped, optionally doped ruthenium catalysts being preferred. Suitable support materials are, for example, silicon dioxide, graphite, titanium dioxide having the rutile or anatase structure, tin dioxide, zirconium dioxide, aluminum oxide or mixtures thereof, preferably titanium dioxide, zirconium dioxide, aluminum oxide or mixtures thereof, particularly preferably γ- or δ-aluminum oxide, tin dioxide or mixtures thereof.

The copper or the ruthenium supported catalysts can be obtained, for example, by impregnation of the support material with aqueous solutions of CuCl₂ or RuCl₃ and optionally a promoter for doping, preferably in the form of their chlorides. The shaping of the catalyst can be carried out after or, preferably, before the impregnation of the support material.

Suitable promoters for doping of the catalysts are alkali metals, such as lithium, sodium, potassium, rubidium and cesium, preferably lithium, sodium and potassium, particularly preferably potassium, alkaline earth metals, such as magnesium, calcium, strontium and barium, preferably magnesium and calcium, particularly preferably magnesium, rare earth metals, such as scandium, yttrium, lanthanum, cerium, praseodymium and neodymium, preferably scandium, yttrium, lanthanum and cerium, particularly preferably lanthanum and cerium, or mixtures thereof.

The shaped bodies can then be dried, and optionally calcined, at a temperature of from 100 to 400° C., preferably 100 to 300° C., for example under a nitrogen, argon or air atmosphere. Preferably, the shaped bodies are first dried at 100 to 150° C. and then calcined at 200 to 400° C.

The conversion of hydrogen chloride in a single pass can preferably be limited to 15 to 95%, preferably 40 to 90%, particularly preferably 50 to 90%. Some or all of the unreacted hydrogen chloride can be recycled into the catalytic hydrogen chloride oxidation after being separated off. The volume ratio of hydrogen chloride to oxygen at the reactor intake is preferably 1:1 to 20:1, preferably 1:1 to 8:1, particularly preferably 1:1 to 5:1 .

The heat of reaction of the catalytic hydrogen chloride oxidation can be used in an advantageous manner for generation of high pressure steam. This can be used for operation of a phosgenation reactor and/or of distillation columns, in particular isocyanate distillation columns.

In a further step, the chlorine formed is separated off. The separating off step conventionally comprises several stages, namely separating off and optionally recycling of ureacted hydrogen chloride from the product gas stream of the catalytic hydrogen chloride oxidation, drying of the stream obtained, which essentially contains chlorine and oxygen, and separating off of chlorine from the dried stream.

The separating off of unreacted hydrogen chloride and of the steam formed can be carried out by condensing aqueous hydrochloric acid out of the product gas stream of the hydrogen chloride oxidation by cooling. Hydrogen chloride can also be absorbed in dilute hydrochloric acid or water.

The adsorption material loaded with inorganic impurities is replaced by fresh absorption agent at expedient intervals of time. The valuable metal compounds contained in the adsorption agent (in particular ruthenium or other noble metal compounds) are removed from the adsorption agent by suitable breakdown processes which are known in principle, and are fed to re-use.

The invention will now be described in further detail with reference to the following non-limiting examples.

### EXAMPLES

### Comparative Example 1 (Experiments D, E & F)

50 g of catalyst of a ruthenium chloride catalyst supported on tin dioxide (RuCl₃ content 4 wt. %) are diluted with 150 g of glass bodies in a fixed bed reactor, and a flow of 40.5 l/h of hydrogen chloride, 315 l/h of oxygen and 252 l/h of nitrogen is passed through the catalyst under 4 bar at 350° C. The conversion of hydrogen chloride is >95%. The water and the unreacted hydrogen chloride are separated off from the product stream, which comprises equal parts of chlorine and water, in addition to unreacted educts and nitrogen, in a condenser. The condensate is then analyzed by means of ICP-OES. A tin content of 72 mg of Sn and a ruthenium content of 0.5 mg per kg of condensate on average result. The individual measurement values are reproduced under D to F in Table 1.

### Example 2 (Experiments A, B & C)

50 g of catalyst are diluted with 150 g of glass bodies in a fixed bed reactor, and a flow of 40.5 l/h of hydrogen chloride, 315 l/h of oxygen and 252 l/h of nitrogen is passed through the catalyst under 4 bar at 350° C. The conversion of hydrogen chloride is >95%. The hot product gas stream (195° C.) is passed over an adsorber (γ-Al₂O₃, manufacturer Saint-Gobain, type SA3177, 3 mm pellets) to a condenser. The water and the unreacted hydrogen chloride are separated off from the product stream, which comprises equal parts of chlorine and water, in addition to unreacted educts and nitrogen, in a condenser. The condensate is then analyzed by means of ICP-OES. A tin content of on average ≦1 mg of Sn per kg of condensate results. The ruthenium content is below the detection limit. The measurement values are reproduced under A to C in Table 1.

TABLE 1
Sn and Ru content in the condensate (with and without an adsorber).

| Experiment | A | B | C | D | E | F |
|---|---|---|---|---|---|---|
| Sn [mg/kg cond.] | 1.17 | 0.94 | 0.50 | 63 | 75 | 78 |
| Ru [mg/kg cond.] | <0.1 | <0.1 | <0.1 | 0.61 | 0.11 | 0.85 |

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. A process comprising:
providing a crude gas stream comprising hydrogen chloride and at least one inorganic component;
introducing the crude gas stream into an adsorber bed;
adsorbing at least a portion of the at least one inorganic component from the crude gas stream on the adsorber bed to form a purified HCl gas, and
removing the purified HCl gas from the adsorber bed.

2. The process according to claim 1, wherein the adsorption is carried out at a temperature of at least 120° C.

3. The process according to claim 1, wherein the adsorption is carried out at a temperature of at least 190 to 400° C.

4. The process according to claim 1, wherein the adsorber bed comprises an adsorption agent selected from the group consisting of zeolites, aluminum oxide, silicon dioxide, aluminum silicates, and mixtures thereof.

5. The process according to claim 4, wherein the adsorption agent comprises γ-aluminum oxide.

6. The process according to claim 3, wherein the adsorber bed comprises an adsorption agent selected from the group consisting of zeolites, aluminum oxide, silicon dioxide, aluminum silicates, and mixtures thereof.

7. The process according to claim 6, wherein the adsorption agent comprises γ-aluminum oxide.

8. The process according to claim 1, wherein the adsorber bed comprises an adsorption agent having a specific BET surface area of 10 to 1,000 m²/g.

9. The process according to claim 5, wherein the adsorber bed comprises an adsorption agent having a specific BET surface area of 10 to 1,000 m²/g.

10. The process according to claim 7, wherein the adsorber bed comprises an adsorption agent having a specific BET surface area of 10 to 1,000 m²/g.

11. The process according to claim 1, wherein the adsorber bed comprises an adsorption agent in the form of a fixed bed.

12. The process according to claim 1, wherein the at least one inorganic impurity comprises a compound of a metal selected from the group consisting of titanium, ruthenium, chromium, tin, copper, zirconium, silicon, aluminum, gold, silver, rhodium, iridium, platinum, palladium, bismuth, cobalt, iron, manganese, molybdenum, nickel, magnesium, vanadium and mixtures thereof.

13. The process according to claim 12, wherein the metal compound comprises a chloride, oxide or oxychloride.

14. The process according to claim 1, wherein the adsorption is carried out at a pressure of 1 to 25 bar.

15. The process according to claim 1, wherein the crude gas stream further comprises at least one additional gas selected from the group consisting of chlorine, oxygen, water, inert gases and mixtures thereof.

16. The process according to claim 1, wherein the crude gas stream further comprises an inert gas selected from the group consisting of carbon dioxide, nitrogen, helium, neon, argon, krypton and mixtures thereof.

17. The process according to claim 1, further comprising dissolving the purified HCl gas in a liquid selected from the group consisting of water and dilute hydrochloric acid to separate hydrogen chloride from the purified HCl gas.

18. The process according to claim 17, further comprising feeding the separated hydrogen chloride to a subsequent process selected from the group consisting of hydrochloric acid electrolyses, acid catalyzed reactions, and base neutralizations.

19. A process comprising: oxidizing hydrogen chloride to form chlorine and a product stream comprising unreacted hydrogen chloride, wherein at least a portion of the product stream comprising the unreacted hydrogen chloride is subjected to the process according to claim 1.
